(19) United States
(12) Patent Application Publication
(10) Pub. No.: US 2004/0115423 A1
(43) Pub. Date: Jun. 17, 2004

(54) Polymer film, preparation method thereof and method for protecting and cleaning a surface using said film

(76) Inventors: Franck Rouppert, St Pierre De Bressieux (FR); Annie Rivoallan, Villebon Sur Yvette (FR); Christophe Largeron, Meylan (FR)

Correspondence Address: BURNS DOANE SWECKER & MATHIS L L P, POST OFFICE BOX 1404, ALEXANDRIA, VA, 22313-1404, US

(21) Appl. No.: 10/472,281

(22) PCT Filed: Mar. 27, 2002
(86) PCT No.: PCT/FR02/01062

(30) Foreign Application Priority Data
Mar. 28, 2001 (FR) 01/04171

(51) Int. Cl. B32B 5/16

(52) U.S. Cl. 428/323; 428/500

(57) ABSTRACT

The present invention relates to a film, dispersible as an emulsion in water, comprising at least one polymer and containing at least one chelating or complexing agent.

The invention also relates to the process for preparing or forming such a polymer film.

Finally, the invention relates to a process for protecting a surface with regard to contaminants or pollutants using said film and to a process for cleaning or decontaminating a surface likewise using said film.

### DESCRIPTION

The present invention relates to a polymer film.

The invention also relates to the process for preparing or forming such a polymer film.

Finally, the invention relates to a process for protecting a surface with respect to contaminants or pollutants using said film and to a process for cleaning or decontaminating a surface likewise using said film.

The technical field of the invention can be defined generally as that of the cleaning or decontaminating of surfaces and of the protecting of these surfaces with respect to contaminants or pollutants, whether the latter are chemical, radioactive, biological or bacteriological.

More specifically, the field of use is that of the maintenance, decontamination and dismantling of plants in the nuclear industry.

The cleaning and/or protecting of surfaces using polymer films is known. Nonpeelable polymer films and peelable polymer films are essentially recognized.

Such films are described in particular in the document “Decommissioning Technology Descriptions: Decontamination”, U.S. Department of Energy, Jan. 8, 2000.

As regards nonpeelable polymer films, products comprising epoxides or polyurethanes are currently used to form “stabilizing” or “fixing” coatings, mainly on painted or unpainted concrete surfaces. These substances can be used to form thin or thick films or to impregnate the surface porosity of the surface to be treated.

The aim is to immobilize the contamination to prevent it from disseminating and to limit the risks of exposure of people and other materials. Such films exhibit the major disadvantage that they do not make possible the decontamination of the underlying surface.

Furthermore, polymers capable of forming peelable or self-peelable surface films are commercially available. However, they only make it possible to remove external contamination at the surface, which excludes volatile contaminants of caesium type. These films mechanically immobilize the contaminant particles, which are thus removed when the film is taken off. These films are generally taken off by tearing off or peeling but some polymers, which are self-peelable, have the distinguishing feature of naturally cracking, thus allowing them to be removed by suction with the contaminants.

Recently, more complicated films have been developed by the Russian Institute for Research and Development VNIIM to facilitate the dismantling of nuclear plants. These films, formed from acrylic and vinyl polymers in aqueous solution, can comprise complexing agents, so as to improve the retention of the contaminants. They give good results in terms of decontamination factor with regard to pollutants of PuO₂ type.

However, this technology has certain disadvantages, for example:

the polymers used are soluble and therefore they are difficult to recover, in particular by flocculation;

the process is only effective with regard to solid particles;

the formulations used are aggressive with regard to the surface as they are optimized for dismantling;

the complexing agents used, such as oxalic acid, are soluble and therefore cannot be recovered by filtration.

It emerges from the preceding study that there exists a need for a polymer film allowing the decontamination, cleaning and/or protection of various surfaces, in particular of metal surfaces, which makes it possible to remove pollutants or contaminants, whatever they are, not only at the surface but also in an underlying surface layer found in the vicinity of this surface.

In other words, there exists a need for a polymer film, and a cleaning or protecting process employing this polymer, which makes it possible to preventively or curatively trap contaminants in a sacrificial surface layer of a surface, for the purposes of decontaminating, cleaning or protecting said surface.

In addition, there exists a need for a film which can be easily and completely removed after it has been used and which makes possible easy separation and easy recovery of trapped polluting contaminants and constituents. In other words, the film and the process must provide for excellent recovery and purification of the materials which can be recovered in value, going hand in hand with a low impact on the environment. This film and the process employing it must furthermore be effective with respect to all contaminants, whatever their form: solid particles, liquids and others, and their nature: chemical, radioactive, biological and others. Finally, this film and the process must be inexpensive, be easy to implement, safe and reliable, and not very aggressive with respect to the surface treated, and, if possible, retain, at the surface, the visual appearance of an untreated surface.

The aim of the present invention is to provide a polymer film and a process for cleaning, decontaminating or protecting a surface which responds to all the needs mentioned above and which satisfies the requirements and conditions set out above for such a process.

The aim of the present invention is also to provide a film and a process which do not exhibit the disadvantages, failings, limitations and inconveniences of the films and processes of the prior art and which solve the problems of the prior art.

This aim and yet others are achieved in accordance with the invention by a film, dispersible as an emulsion in water, comprising a polymer and containing at least one chelating or complexing agent. The film is advantageously nonporous, that is to say that it does not exhibit any porosity, whether open or closed.

This polymer film is essentially distinguished from the films of the prior art in that this film, which comprises a chelating or complexing agent, comprises a polymer which is generally nonsoluble or insoluble in water. This film is in fact prepared from an aqueous emulsion of said polymer. For this reason, the polymer can be easily recovered, after the film has been used, by re-emulsifying and flocculating, which is not possible with the water-soluble polymers of the films of the prior art.

The film according to the invention meets all the needs, requirements and criteria mentioned above, for example: it makes it possible, with high efficiency and high reliability, to curatively or preventively trap contaminants or pollutants in a sacrificial surface layer on the treated surface, that is to say that it is not only the contamination which is found on the surface which is trapped but also that which is found immediately under this surface. The film according to the invention makes possible control of the dissemination of the contaminant by retaining the latter within itself.

The mechanical, adhesive and cohesive properties of the film are excellent and provide a very good hold over any surface, while making possible easy removal, in particular by peeling.

The film is inexpensive. It can be prepared with products readily available commercially.

The film is not aggressive with respect to the surface to which it is applied. It does not in any way modify the properties of the latter. It does not damage the appearance of it. In addition, in the majority of cases, as the film is colourless and transparent, it does not affect the visual appearance of the surface.

The film is prepared from compounds which are non-toxic with respect to personnel and which have a low impact on the environment.

In addition, all the constituents of the film can be easily separated, recycled and/or destroyed, at low cost, after the film has been used.

The polymer is generally chosen from polymers capable of existing in the form of aqueous emulsions of latex type. The polymer is preferably chosen from styrene-butadiene copolymers and styrene-acrylate copolymers.

The film can advantageously comprise several polymers which preferably exhibit different glass transition temperatures (Tg).

Said chelating or complexing agent or agents is (are) advantageously chosen from chelating or complexing agents which are specific with regard to chemical, radioactive or biological contaminants or pollutants.

Said chelating or complexing agent(s) is (are) preferably chosen from complexing or chelating agents which are specific with regard to volatile contaminants, more preferably with regard to volatile radioactive contaminants, such as caesium.

The film advantageously comprises several chelating or complexing agents, each of which is specific with regard to a determined contaminant or pollutant.

Preferably, each of said specific chelating or complexing agents has a different specific particle size.

The invention also relates to a process for the formation of a film comprising at least one polymer, preferably a polymer which is nonsoluble in water, and at least one chelating or complexing agent on a surface, for the purpose in particular of protecting, cleaning or decontaminating said surface, in which:

an aqueous emulsion of said polymer is formed;

the chelating or complexing agent is incorporated in said emulsion;

said emulsion comprising the polymer and the chelating or complexing agent is applied to the surface, by means of which the film is formed, generally rapidly, in a few minutes, namely, for example, from 1 or 2 to 10 minutes, on the surface, by coalescence.

The formation of the film advantageously takes place by coalescence at ambient temperature or the temperature of use of the surface (temperature at which the surface is found) without any drying of the surface and/or of the components comprising this surface.

This is because, in view of the conditions generally used in employing the emulsion intended to form the film according to the invention, namely with personnel who are not very qualified, in an enclosed space, for example an installation, contaminated, for example, by radioactivity—which imposes time periods for the operations of a few minutes—no additional equipment can be introduced into the plant and used to accelerate the formation and the drying of the film. It is therefore an important advantage of the film and of the process of the invention to be able to make possible drying-free formation.

According to the invention, the formation of the film can be carried out at ambient temperature without any heating of the components to be covered and without use of hot air, including on vertical surfaces, which is particularly advantageous in the case in particular of use in a contaminated enclosed space.

The coalescence conditions are advantageously chosen so as to avoid any porosity, whether open or closed, in the final film formed.

However, under some conditions of use, the process of the invention additionally comprises, subsequently, a final stage of drying of the film.

The formation and the optional drying of the film are carried out according to the invention without any draining or any absorption of any of the liquids participating in the composition of the emulsion.

The invention additionally relates to a process for cleaning or decontaminating a surface, in which a film is formed on said surface by the process described above, said surface then being a contaminated or polluted surface.

The invention also relates to a process for protecting a surface, in which a film is formed on said surface by the process described above, said surface then being a clean surface devoid of pollutants or contaminants.

In the case of a decontaminating or cleaning process, the film is left in contact with the surface until it is saturated with contaminants or pollutants, for a period of time, for example, from a few days, for example 1 or 2 to 10 days, to several months, for example 1 or 2 to 10 months, and then is removed, when it is saturated with pollutants or contaminants.

Likewise, in the case of a protecting process, the film is left in contact with the surface until it is saturated with pollutants or contaminants and then the saturated film is removed from the surface, when it is saturated with pollutants or contaminants and when it can no longer efficiently carry out its role of protecting.

The film saturated with pollutants or contaminants can be removed by peeling, tearing off, blasting or abrasion or by (re)dissolution in an aqueous medium.

In the case where removal is carried out by dissolution of the film in an aqueous medium, an aqueous solution or emulsion comprising the organic material, the complexing or chelating agents and the contaminants or pollutants is thus obtained. The organic material is separated from the solution by flocculation and then filtration. Generally, it is subsequently discharged or removed, for example by incineration.

The chelating or complexing agents and the contaminants or pollutants are separated by filtration.

The invention will now be described in detail in the description which follows, given by way of illustration and without implied limitation.

In a first step, the starting point is the formulation or preparation of an aqueous emulsion of one or more polymers of latex type.

The term “polymer” is understood to mean, in the present description, both homopolymers and copolymers prepared from several monomers.

Mention may be made, among preferred polymers and copolymers, of copolymers of styrene with butadiene or of styrene with an acrylate.

Use is preferably made of a commercially available aqueous latex emulsion; examples of such emulsions are the emulsions available from Bayer® under the name Baystal®.

These emulsions exhibit in particular the advantage of low cost, generally less than ten francs per kilogram, of very low toxicity and of absence of organic solvent.

The emulsion can comprise only a single polymer but it can also comprise two or more of them, these polymers having, for example, different glass transition temperatures (Tg), so as to obtain a compromise between the adhesion and the cohesion of the film suited to the surface to be treated.

Thus, a first polymer can have a Tg of −30° C. to −5° C. and a second polymer a Tg of +5° C. to +50° C.

As a blend, it will be possible, for example, to use a blend of styrene-butadiene and styrene-acrylate latices preferably having different glass transition temperatures.

When several latices are used, the emulsion is generally prepared by simple mixing of the various latices, preferably with stirring.

One or more chelating and/or complexing agents is (are) subsequently incorporated in the aqueous emulsion containing one or more polymers.

This or these chelating and/or complexing agent(s) is (are) preferably incorporated in the emulsion in the form of a particulate solid, for example of a powder, and the mixture is generally homogenized by kneading.

The complexing agent or agents is (are) generally each specific with regard to a contaminant or pollutant which it is desired to remove from the surface or when it is desired to protect this surface.

Thus, the complexing/chelating agent or agents will be chosen, for example, from complexing/contaminating agents which are specific with regard to caesium, cobalt, ruthenium, and the like.

The complexing/chelating agents will be chosen, for example, from metal or alkali metal ferrocyanides, such as cobalt ferrocyanide or potassium ferrocyanide, or mixed ferrocyanides of a metal and of an alkali metal (such as potassium), such as the mixed ferrocyanide of cobalt and of potassium, which has a particle size generally of 100 to 500 μm and which is specific with regard to caesium.

In this respect, it is important to note that it is advantageous to use mixtures of chelating/complexing agents with different particle sizes, for example with particle sizes which are different according to the contaminants to be trapped or to be repelled; the complex or chelated contaminants can subsequently thus be easily separated by cascade filtration.

The aqueous emulsion of the polymer or polymers comprising the chelating agent or agents is subsequently applied to the surface to be cleaned, decontaminated or protected.

There is no limitation on the nature and the form of the surface to be treated. This surface can be a metal or polymer or glass surface; the surface is preferably nonporous or nonabsorbent.

In fact, the emulsion is advantageously formulated so as to make possible the formation of a nonporous film on a nonporous support and the application of the emulsion must be possible on nonabsorbent supports, such as the metals, glass and other plastic supports mentioned above.

The surface can be opaque or transparent; one of the advantages of the invention is that of making possible the treatment or protection of transparent surfaces, such as that of spectacles or windows, because the film formed according to the invention is generally transparent and colourless and therefore does not mask the surface. This is particularly advantageous on transparent surfaces.

According to the invention, the surface can have any form, and both surfaces with a simple form and surfaces with a complex form can be treated with the same effectiveness.

This surface is in particular a surface found in a plant of the nuclear industry, whether it is the surface of a building, of an enclosed space or of a device, or other equipment.

The emulsion can be applied to the surface by any known means, for example by spreading with a brush or with a roller or alternatively by spraying.

The film is formed (for example in a time of 1 to 30 minutes) by “in situ” coalescence of the polymer on the surface.

The formation of the film is rapid at the temperature of use of the equipment, part of which is formed by the surface. By way of example, this temperature can be from 5 to 50° C.

The film can generally be subsequently dried, for example by evaporation, at a temperature of 5 to 50° C.

The film generally becomes transparent on drying. For this reason, the surface retains the visual appearance of an untreated surface. Said film, once formed, has a role of protecting agent with regard to surface contamination or a role of decontaminating or cleaning agent for said surface.

In other words, the film can be applied preventively to a clean surface, as protecting agent with regard to contamination, or else it can be applied curatively to decontaminate or clean the surface.

The contaminants and/or pollutants which can be removed from the surface or with regard to which the surface can be protected are of various natures. They can in particular be chemical contaminants or pollutants, such as Pb or Cd, and/or radioactive contaminants, such as caesium, or biological contaminants (for example bacteriological contaminants).

In particular, the contaminants treated or repelled by the film according to the invention are volatile contaminants and in particular volatile radioactive contaminants of caesium type. The role of the film is, for example, to immobilize, to trap or to isolate the contamination and in particular volatile radioactive contamination of caesium type. A specific chelating/complexing agent corresponds to each contaminant/pollutant. In the case of caesium, it has been seen that this chelating/contaminant agent is, for example, cobalt potassium ferrocyanide. The isolation, immobilization or fixing of the contamination, in particular of volatile contamination of caesium type, is carried out in the following way:

the surface is protected with regard to contamination by complexing and/or by blocking the reactions of adsorption and chemisorption on the surface. The contaminant or pollutant is immobilized in the film before reaching the surface; or else

the contamination, already absorbed or chemisorbed, for example of caesium type, is removed by desorption or ion exchange and then complexing by the chelating or complexing agent specific for the contaminant in the film, which is subsequently removed.

The polymer film can subsequently be removed by various processes which are essentially mechanical processes and/or chemical processes.

A first possibility is peeling or tearing off the film.

Peeling or tearing off is generally carried out in the following way: by pulling on an edge using a pair of pliers.

A second possibility is blasting or abrasion of the surface using, for example, solid carbon dioxide (dry ice) or other material.

A third possibility is the dissolution of the film, preferably in an aqueous medium; this dissolution can be carried out, for example, by spraying with pressurized water.

In the case where the film is dissolved in an aqueous medium, the organic material is separated by flocculation by introducing a specific Bayer® flocculent and then by filtration of the flocs thus formed. The organic material thus recovered can be destroyed by incineration.

The complexing agents, flocculating agents and contaminants are, for their part, separated by filtration, generally in the form of insoluble granules.

If chelating or complexing agents, such as cobalt ferrocyanide or potassium ferrocyanide, with different particle sizes (for example, 10 μm to 500 μm), according to the contaminant to be trapped, are chosen, said contaminants or pollutants trapped by the complexing/chelating agents can be separated by cascade filtration from the coarsest to the finest.

The film and the processes according to the invention find their application in any treatment which is preventive and/or curative with regard to the contamination or pollution—whatever the nature and the form thereof—of any surface and of any industrial equipment.

The film and the processes according to the invention make it possible to decontaminate or clean various surfaces or to protect them with regard to decontamination or pollution at low cost, to isolate and to avoid the dissemination of contaminants, and to make possible recovery and purification of the materials which can be recovered in value, while having only a slight impact on the environment and while retaining, at the surface, the visual appearance of an untreated surface.

In particular, in the nuclear industry, the film and the processes according to the invention exhibit, inter alia, the following advantages:

a reduction in the dose rates in the plants and, for this reason, a limitation on the doses incorporated by operating personnel;

the possibility of increasing the operating times of personnel in the plants concerned and the simplification of the management of maintenance teams;

the limitation of the volume of effluents in comparison with plants using decontamination by the wet route (this advantage is not limited to nuclear plants);

the extension of the lifetime of the equipment;

lower operating costs.

For example, the regular application and removal of the film according to the invention makes it possible to maintain in the rear areas of vitrification plants a lower level of ambient radioactivity for a longer time, resulting in longer possible operating times for personnel, with incorporation of lower doses and an increase in the lifetime of the equipment.

1. Film, dispersible as an emulsion in water, comprising at least one polymer and containing at least one chelating or complexing agent.

2. Film according to claim 1, characterized in that it is nonporous.

3. Film according to claim 1, in which the polymer is chosen from polymers capable of existing in the form of aqueous emulsions of latex type.

4. Film according to any one of claims 1 to 3, in which the polymer is chosen from styrene-butadiene copolymers and styrene-acrylate copolymers.

5. Film according to any one of claims 1 to 4, comprising several polymers preferably exhibiting different transition temperatures.

6. Film according to any one of claims 1 to 5, in which said chelating or complexing agent or agents is (are) chosen from chelating or complexing agents which are specific with regard to chemical, radioactive or biological contaminants or pollutants.

7. Film according to claim 6, in which said chelating or complexing agent or agents is (are) chosen from complexing or chelating agents which are specific with regard to volatile contaminants.

8. Film according to claim 7, in which said volatile contaminants are radioactive contaminants, such as caesium.

9. Film according to any one of claims 1 to 8, comprising several complexing or chelating agents, each of which is specific with regard to a determined contaminant or pollutant.

10. Film according to claim 9, in which each of said specific complexing or chelating agents has a different specific particle size.

11. Process for the formation of a film according to any one of claims 1 to 10 comprising at least one polymer, preferably a polymer which is nonsoluble in water, and at least one chelating or complexing agent on a surface, in which:
an aqueous emulsion of said polymer is formed;
the chelating or complexing agent is incorporated in said emulsion;
said emulsion comprising the polymer and the chelating or complexing agent is applied to the surface, by means of which the film is formed by coalescence.

12. Process according to claim 11, in which the formation of the film takes place by coalescence at ambient temperature or the temperature of use of the surface.

13. Process according to claim 11, additionally comprising, subsequently, a final step of drying of the film.

14. Process according to any one of claims 11 to 13, in which the coalescence conditions are chosen so as to avoid any porosity in the final film formed.

15. Process for protecting a surface, in which a film is formed on said surface by the process according to any one of claims 11 to 14, said surface being a clean surface devoid of pollutants or contaminants.

16. Process for decontaminating or cleaning a surface, in which a film is formed on said surface by the process according to any one of claims 11 to 14, said surface being a contaminated or polluted surface.

17. Process according to claim 15 or claim 16, in which the film is left in contact with the surface until it is saturated with contaminants or pollutants and then it is removed.

18. Process according to claim 17, in which the film saturated with contaminants or pollutants is removed by peeling, tearing off, blasting or abrasion.

19. Process according to claim 17, in which the film is removed by dissolution in an aqueous medium, by means of which a solution or emulsion comprising the organic material, the complexing or chelating agents, and the contaminants or pollutants is obtained.

20. Process according to claim 19, in which the organic material is separated from the solution or emulsion by flocculation and then filtration and subsequently discharged or removed, for example by incineration.

21. Process according to claim 19, in which the chelating or complexing agents and the contaminants or pollutants are separated by filtration.

22. Process according to claim 21, in which the chelating or completing agents have different particle sizes according to the contaminant to be trapped and said contaminants or pollutants trapped by said complexing or chelating agents are separated by cascade filtration.
